(19) United States
(12) Patent Application Publication
(10) Pub. No.: US 2014/0083996 A1
(43) Pub. Date: Mar. 27, 2014

(54) Package Bag For Microwave Cooking

(71) Applicants: Toshikazu Kenmotsu, Niiza-shi (JP); Daisaku Ishikawa, Fujimi-shi (JP)

(72) Inventors: Toshikazu Kenmotsu, Niiza-shi (JP); Daisaku Ishikawa, Fujimi-shi (JP)

(21) Appl. No.: 14/119,442

(22) PCT Filed: May 23, 2012
(86) PCT No.: PCT/JP2012/063153

§ 371 Date: Nov. 21, 2013

(30) Foreign Application Priority Data
May 23, 2011 (JP) 2011-114847

(51) Int. Cl. H05B 6/80

(52) U.S. Cl. CPC H05B 6/80
USPC 219/725

(57) ABSTRACT

The package bag for microwave cooking includes: a back seal portion formed by heat-sealing a pair of edges of a resin sheet which are opposed to each other; and edge seal portions formed by heat-sealing edges of the resin sheet so as to intersect with the back seal portion. The resin sheet includes a base material and a heat-seal layer provided on one surface of the base material, and the back seal portion is provided with an opening start portion used to tear the resin sheet. In the resin sheet, at least one opening auxiliary portion formed by linearly cutting the base material is provided on each of both sides of the back seal portion, and the opening auxiliary portion is disposed in a position to which a tear caused in the resin sheet when the package bag is opened from the opening start portion proceeds.

### TECHNICAL FIELD

The present invention relates to a package bag suitable for steam cooking of packaged food with a microwave.

Priority is claimed on Japanese Patent Application No. 2011-114847, filed May 23, 2011, the content of which is incorporated herein by reference.

### BACKGROUND ART

Food may be cooked from heating in a microwave while being contained in a package bag.

In general, when food is heated in a microwave while being contained in a package bag, water vapor is generated from the inside of the food, and thus the package bag swells and is eventually ruptured.

Therefore, measures for preventing the rupture have been devised for a package bag for microwave cooking. For example, Patent Document 1 discloses a package bag for microwave heating which includes two resin film layers constituting the package bag, wherein the resin film on the surface side thereof has a slit.

### DOCUMENT OF RELATED ART

### Patent Document

[Patent Document 1] Japanese Unexamined Patent Application, First Publication No. 2008-110763

### SUMMARY OF INVENTION

### Technical Problem

Among foods which are cooked with a microwave while being contained in a package bag, there are foods (for example, pork dumplings, Chinese steamed buns, and the like) which are steam-cooked by water vapor which is generated from the foods during heating.

However, the package bag described in Patent Document 1 is adapted to easily emit the water vapor generated by the heating to the outside thereof, but is not adapted for ease of opening thereof after cooking. It may therefore not be easy to remove the heated food from the package bag.

The present invention aims to provide a package bag for microwave cooking which can keep a sufficient amount of water vapor generated from packaged food inside so as to sufficiently steam the food, and from which food can be easily removed.

According to an aspect of the present invention, a package bag for microwave cooking is a package bag in which food is seal-packaged, the package bag including: a back seal portion formed by heat-sealing a pair of edges of a resin sheet which are opposed to each other; and edge seal portions formed by heat-sealing edges of the resin sheet so that the edge seal portions intersect with the back seal portion. In addition, the resin sheet includes a base material and a heat-seal layer provided on one surface of the base material, and the back seal portion is provided with an opening start portion used to tear the resin sheet. In the resin sheet on a side on which the back seal portion is formed, at least one opening auxiliary portion formed by linearly cutting the base material is provided on each of both sides of the back seal portion, and the opening auxiliary portion is disposed in a position to which a tear caused in the resin sheet when the package bag is opened from the opening start portion proceeds.

In this case, a lamination strength between the base material and the heat-seal layer in the resin sheet may be 0.1 N/15 mm to 3.0 N/15 mm.

In addition, the opening auxiliary portion may be formed to be parallel to an extending direction of the back seal portion.

### Effects of Invention

A package bag for microwave cooking of the present invention can keep a sufficient amount of water vapor generated from packaged food inside to sufficiently steam the food, and the food can be easily removed therefrom.

### BRIEF DESCRIPTION OF DRAWINGS

FIG. 1 is a schematic plan view showing a package bag for microwave cooking of an embodiment of the present invention.

FIG. 2 is a cross-sectional view taken along the line I-I′ of FIG. 1.

FIG. 3 is a diagram illustrating the opening of the package bag of FIG. 1.

### DESCRIPTION OF EMBODIMENTS

A package bag for microwave cooking (hereinafter, abbreviated to “package bag”) of an embodiment of the present invention will be described below with reference to the drawings.

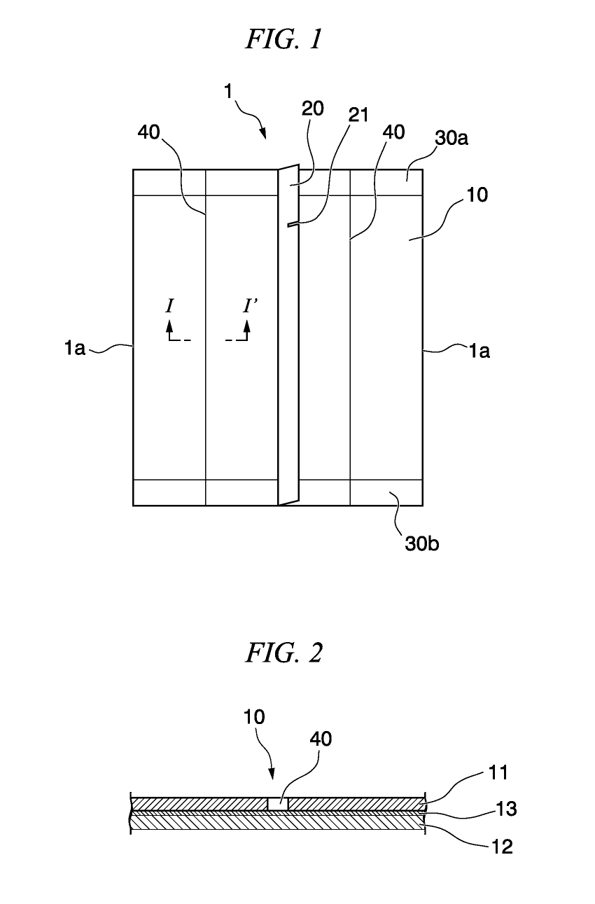

FIG. 1 shows a schematic plan view of the package bag of this embodiment. A package bag 1 of this embodiment is a back-pasted flat bag in which food is seal-packaged, and the back-pasted flat bag is composed of a resin sheet 10 and includes a back seal portion 20 and edge seal portions (first edge seal portion 30a and second edge seal portion 30b).

### (Resin Sheet)

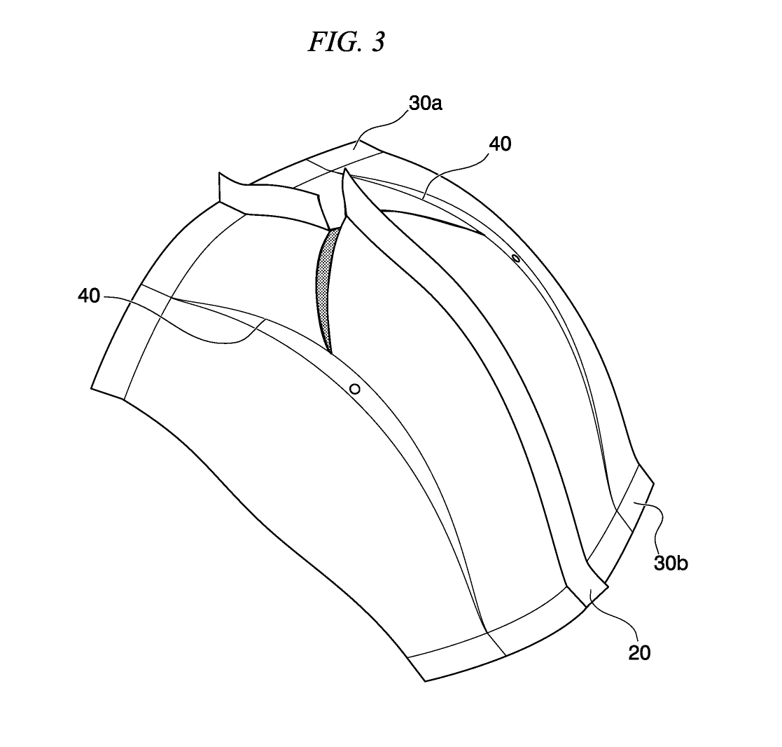

The resin sheet 10 composing the package bag 1 is formed into a rectangular shape in plan view. In addition, as shown in FIG. 2, the resin sheet 10 is a laminate film which includes a base material 11, a heat-seal layer 12 provided on one side of the base material 11 (on the surface on the inner side of the package bag 1), and an adhesion layer 13 which adheres the heat-seal layer 12 to the base material 11.

### (Base Material)

The base material 11 is composed of a resin film.

The base material 11 preferably has heat resistance so as to hardly extend even when being heated in a microwave. Specifically, as the base material 11, a resin film is used which is made from polyester such as polyethylene terephthalate, polyamide, polypropylene, polyvinyl alcohol, an ethylene-vinyl alcohol copolymer, polycarbonate, polyacetal, or the like. In addition, the base material 11 may be a laminate film obtained from subjecting the above materials to multilayer coextrusion. Further, the resin film may be a non-stretched film or a stretched film. However, the resin film is preferably a stretched film in consideration of the fact that the film hardly extends during heating.

The thickness of the base material 11 is preferably 6 μm to 50 μm, and more preferably 9 μm to 30 μm. When the thickness of the base material 11 is equal to or greater than the lower limit (6 μm), heat sealing can be sufficiently carried out, and when the thickness is equal to or less than the upper limit (50 μm), the heat-seal layer 12 can be easily formed.

### (Heat-Seal Layer)

The heat-seal layer 12 is a layer which can be heat-sealed together with another heat-seal layer 12 opposed thereto.

The resin constituting the heat-seal layer 12 preferably has heat resistance at 100° C. or higher. Specifically, polyolefin such as low-density polyethylene, medium-density polyethylene, high-density polyethylene, linear low-density polyethylene, or polypropylene is used.

The thickness of the heat-seal layer 12 is preferably 10 μm to 200 μm, and more preferably 20 μm to 100 μm. When the thickness of the heat-seal layer 12 is equal to or greater than the lower limit (10 μm), heat sealing can be sufficiently carried out, and when the thickness is equal to or less than the upper limit (200 μm), the heat-seal layer 12 can be easily formed.

### (Adhesion Layer)

The adhesion layer 13 is a resin layer which can adhere the base material 11 and the heat-seal layer 12 to each other.

As the adhesive constituting the adhesion layer 13, for example, a polyurethane-based two liquid curable adhesive is used which contains polyester polyol or polyether polyol as a main component.

The coating amount of the adhesive of the adhesion layer 13 is preferably 1.0 g/m² to 5.0 g/m², and more preferably 2.0 g/m² to 4.0 g/m².

### (Lamination Strength)

The lamination strength between the base material 11 and the heat-seal layer 12 has an influence on an applicable time for steaming. That is, when the lamination strength between the base material 11 and the heat-seal layer 12 is too strong, the heat-seal layer 12 is extended at an opening auxiliary portion 40 (to be described later) in a state in which the base material 11 and the heat-seal layer 12 are not separated from each other, and thus a hole is instantaneously formed in the heat-seal layer 12 in a short time after the start of heating, so that an opening is formed therein. Therefore, the state in which the package bag 1 is filled with water vapor cannot be maintained and the time for steaming may be reduced. In addition, since the steam escapes with an explosive sound, a cook may be surprised.

On the other hand, when the lamination strength between the base material 11 and the heat-seal layer 12 is appropriate, the heat-seal layer 12 is extended at the opening auxiliary portion 40 while the base material 11 and the heat-seal layer 12 are separated from each other. Thus, first, a through-hole with an approximately pinhole size through which steam escapes is formed in the heat-seal layer 12. Thereafter, this through-hole is gradually enlarged. However, since the size of the through-hole is maintained so as to be balanced with the inner pressure of the package bag 1, only minimum water vapor is released to the outside thereof. As a result, the state in which the package bag 1 is filled with water vapor can be maintained, and thus a sufficient steam effect can be obtained. In addition, since the noise from the escaping steam is small, a cook can be prevented from being surprised or scared.

Specifically, the lamination strength between the base material 11 and the heat-seal layer 12 is preferably 0.1 N/15 mm to 3.0 N/15 mm, and more preferably 0.5 N/15 mm to 2.0 N/15 mm.

The coating amount of the adhesive constituting the adhesion layer 13 may be appropriately adjusted in order to obtain the above-described lamination strength. In addition, an aqueous adhesive containing water or alcohol as a solvent may be used as the adhesive constituting the adhesion layer 13, and an extrusion lamination method, a non-solvent lamination method, a thermal lamination method or the like may be selected as an adhesion method.

### (Back Seal Portion)

The back seal portion 20 is formed by heat-sealing a pair of edges together of the resin sheet 10 which are parallel to each other. In addition, in the back seal portion 20, the heat-sealing is applied to the surface on the side of the heat-seal layer 12 of the resin sheet 10. In this embodiment, the surfaces on the side of the heat-seal layer 12 at both edges in the longitudinal direction of the resin sheet 10 are brought into contact with each other to heat-seal the heat-seal layers 12 and 12 together which contact each other, whereby the back seal portion 20 is formed.

The seal width of the back seal portion 20 (that is, the length in the transverse direction of the back seal portion 20) is preferably 10 mm to 30 mm. When the seal width of the back seal portion 20 is equal to or greater than the lower limit, the back seal portion 20 can be easily pinched and opened even when the package bag 1 is heated by microwave cooking. On the other hand, when the seal width of the back seal portion 20 is greater than the upper limit, the openability is improved, but the swelling of the package bag 1 during the microwave cooking is disturbed, and thus the steam escape performance may be deteriorated. In addition, the cost may increase due to an increase in the amount of the resin sheet 10 used.

The back seal portion 20 is provided with an opening start portion 21.

The opening start portion 21 is a portion used to easily tear the back seal portion 20 in order to easily open the package bag 1. In this embodiment, the opening start portion 21 is an I-notch which is a linear slit formed so as to extend in the width direction of the back seal portion 20. The I-notch is preferable as the opening start portion 21 from the viewpoint of the openability.

A mark indicating the opening position or the opening direction of the opening start portion 21 may be printed in the vicinity of the opening start portion 21.

In addition, the opening start portion 21 may be formed in the vicinity of an end in the extending direction of the back seal portion 20 in order to enlarge an opening portion of the package bag 1 during opening. In FIG. 1, the opening start portion 21 is formed in the vicinity of the first edge seal portion 30a.

When the back seal portion 20 is pulled in directions opposite to each other from the opening start portion 21 as a center, the back seal portion 20 is torn in the width direction from the opening start portion 21. When the back seal portion 20 is further pulled, the resin sheet 10 in the vicinity of the back seal portion 20 is sequentially torn. The tear caused in the resin sheet 10 proceeds in a direction which departs from the back seal portion 20 (that is, in the substantially left-and-right direction of FIG. 1, hereinafter, this direction may be referred to as the “tearing direction”).

### (Edge Seal Portion)

The first edge seal portion 30a and the second edge seal portion 30b are formed by heat-sealing edges of the resin sheet 10 so that the first and second edge seal portions 30a and 30b are perpendicular to (intersect with) the extending direction of the back seal portion 20.

The seal width of each of the edge seal portions 30a and 30b is preferably 5 mm to 30 mm. When the seal width of each of the edge seal portions 30a and 30b is equal to or greater than the lower limit, the package bag 1 can be sufficiently sealed even when swollen. However, when the seal width of each of the edge seal portions 30a and 30b is greater than the upper limit, the practicability of the package bag 1 is deteriorated.

### (Opening Auxiliary Portion)

The resin sheet 10 on the side on which the back seal portion 20 is formed is provided with the opening auxiliary portions 40 which are formed by linearly cutting the base material 11 and by not cutting the heat-seal layer 12. The opening auxiliary portion 40 is disposed ahead of the tip of the opening start portion 21, that is, disposed in a position to which the tear which is caused in the resin sheet 10 when the package bag is opened from the opening start portion 21 proceeds. In other words, the opening auxiliary portion 40 is disposed so as to intersect with the tearing direction of the resin sheet 10. Since the base material 11 is cut at the opening auxiliary portion 40, the tearing strength therein is less than that in a portion in which the base material 11 is not cut.

In this embodiment, the opening auxiliary portion 40 has a linear shape, one opening auxiliary portion is provided on each of both sides of the back seal portion 20 so as to be parallel to the back seal portion 20, and the length thereof is the same as that in the extending direction of the back seal portion 20. In addition, the distance between each opening auxiliary portion 40 and the back seal portion 20 is the same.

The opening auxiliary portion 40 may be a continuous line or a broken line.

The distance between each opening auxiliary portion 40 and the base portion (base) of the back seal portion 20 is preferably such a distance in which food can be easily removed when the package bag is opened.

Specifically, when the distance between the opening auxiliary portion 40 and the back seal portion 20 is represented by X and the distance between a side edge 1a of the package bag 1 and the back seal portion 20 is represented by Y, X/Y is preferably 0.15 to 0.65, and more preferably 0.20 to 0.40. When X/Y is equal to or greater than the lower limit, the package bag 1 has an opening with a sufficient size when being opened, and thus food can be more easily removed. When X/Y is equal to or less than the upper limit, the package bag easily swells during the heating with a microwave, and thus steam cooking can be sufficiently performed.

### (Manufacturing Method)

The package bag 1 of this embodiment is manufactured as follows.

First, two slits which will be the opening auxiliary portions 40 are formed in parallel in the base material 11 using a slitter. The base material 11 is laminated on the heat-seal layer 12 with the adhesion layer 13 interposed therebetween to obtain the resin sheet 10. Next, the obtained resin sheet 10 is cut into a rectangular shape such that an edge which is parallel to the opening auxiliary portion 40 becomes a short side and one opening auxiliary portion 40 is provided on each of both sides of the back seal portion 20.

Next, the resin sheet 10 is folded back in a central portion in the longitudinal direction of the cut resin sheet 10 such that the surfaces at both edges on the side of the heat-seal layer 12 are brought into contact with each other. Thereafter, the heat-seal layers 12 and 12 at both edges in the longitudinal direction of the resin sheet 10 are heat-sealed together to form the back seal portion 20. At this time, the resin sheet 10 is formed into a tubular shape.

Next, in order to form a bottom portion, the edge of the resin sheet 10 which opens and which is located on the side of one end in the extending direction of the back seal portion 20 is heat-sealed to form the second edge seal portion 30b.

Next, food is put through the edge of the resin sheet 10 which opens on the opposite side to the second edge seal portion 30b used as a bottom portion, in the inside thereof. Then, the edge of the resin sheet 10 which opens is heat-sealed and thus the first edge seal portion 30a is formed.

Next, a slit is formed in the back seal portion 20 in the width direction thereof to form the opening start portion 21 as an I-notch, whereby the package bag 1 is obtained.

### (Food)

Food which is packaged in the package bag 1 is steam-cooked with water vapor generated from the inside of the food when being heated in a microwave. Examples of this type of food include Chinese steamed buns and pork dumplings.

### (Functions and Effects)

When cooking food which is contained in the package bag 1, the food is placed at a predetermined position inside a microwave while packaged, and is heated for an appropriate amount of time. Since water vapor is generated from the inside of the food during the heating, the pressure in the package bag 1 increases. At the time when the pressure in the package bag 1 reaches a predetermined pressure, a through-hole with an approximately pinhole size through which steam escapes is formed in the heat-seal layer 12 of the opening auxiliary portion 40 of the package bag 1, and thus the water vapor in the package bag is emitted. In the package bag 1, the through-hole is not instantaneously formed in a short time after the start of heating, and is gradually formed having a minimum size. Therefore, the emission of the water vapor generated from the food can be suppressed to a minimum, and the water vapor can be kept for a sufficient time in the package bag 1. Therefore, the packaged food can be sufficiently steamed.

After the cooking, when the package bag 1 is opened from the opening start portion 21, the package bag 1 is torn in order from the back seal portion 20 to the resin sheet in the vicinity of the back seal portion 20, and as shown in FIG. 3, the tip of the tear proceeds toward the opening auxiliary portion 40. After the tip of the tear reaches the opening auxiliary portion 40, the package bag 1 is further torn along the opening auxiliary portion 40 the tearing strength of which is decreased. Since the area which is partitioned by the tear of the resin sheet starting from the opening start portion 21 and both opening auxiliary portions 40 becomes an opening portion of the package bag 1, the package bag 1 is widely opened. Therefore, it is possible to easily remove the cooked contents without them getting caught in the opening portion to make scratches on the surface of the contents, or without other issues such as them losing their shape. Moreover, by pinching and opening the back seal portion 20, it is possible to prevent hands from touching the resin sheet directly contacting the contents which become the hottest after the cooking, and to reduce the heat felt by the cook.

Furthermore, in the package bag 1, since the through-hole formed from the steam escape is small, the sound occurring upon opening is small, and thus big sounds which may surprise or scare the cook hardly occur.

The present invention is not limited to the above embodiment.

The direction in which the I-notch as the opening start portion 21 is formed does not have to be in the width direction of the back seal portion 20, and may be in any direction as long as the package bag 1 can be opened. The opening start portion 21 is not limited to the I-notch, and may be a V-notch, a turtle shell notch, a portion obtained by subjecting a surface of the back seal portion 20 to roughening, or the like.

In addition, in the present invention, the opening auxiliary portion 40 does not have to be parallel to the back seal portion 20. For example, the opening auxiliary portion 40 may be gradually separated from the back seal portion 20 in the direction from one edge seal portion (in the drawing, the first edge seal portion 30a) toward the other edge seal portion (in the drawing, the second edge seal portion 30b). The opening auxiliary portion 40 may be formed to be parallel to the side edge 1a of the package bag 1.

In addition, regarding the opening auxiliary portion 40, at least one opening auxiliary portion 40 only has to be provided on each of both sides of the back seal portion 20. For example, two opening auxiliary portions may be provided on each of both sides of the back seal portion 20. In addition, the opening auxiliary portions 40 provided on both sides of the back seal portion 20 may be separated from the back seal portion 20 by different distances. In addition, the opening auxiliary portion 40 does not have to be linear, and may be curved.

The package bag 1 of the present invention may not be a back-pasted bag (pillow bag), but be a side gusset bag having folded portions in both sides of the bag.

In addition, in this embodiment, the rectangular resin sheet 10 is used. However, a resin sheet having a shape other than a rectangular shape may be used, and a pair of edges of a resin sheet having a predetermined shape which are opposed to each other may be sealed together to form a back seal portion. In this case, the pair of edges which are opposed to each other may not be parallel to each other.

Furthermore, in this embodiment, the back seal portion 20 and each of the edge seal portions 30a and 30b are perpendicular to each other. However, they do not have to be perpendicular to each other, but only have to intersect with each other.

### EXAMPLES

Hereinafter, the present invention will be described in more detail with examples. In addition, the present invention is not limited to the following examples.

In the following examples, the lamination strength between the base material and the heat-seal layer in the resin sheet is a value which was measured using a tensile tester M-1 manufactured by Toyo Seiki Seisaku-sho, Ltd., under conditions of T-peeling and a tension rate of 300 mm/min. The measurement was performed three times, and the range and the average of the lamination strength were obtained.

### Example 1

A package bag of this example had a configuration similar to that in FIG. 1. In the package bag of this example, the resin sheet was heat-sealed to form a back seal portion 20 and edge seal portions 30a and 30b, and a Chinese steamed bun (bean-paste bun) was packaged therein. The seal width of the back seal portion 20 was 20 mm. The length of the package bag 1 in the direction parallel to the back seal portion 20 was 160 mm, and the length of the package bag 1 in the direction parallel to the edge seal portions 30a and 30b was 140 mm.

In this package bag 1, one opening auxiliary portion 40 in which only a base material is cut and which was parallel to the back seal portion 20 was provided on each of both sides of the back seal portion 20 on the same side as the back seal portion 20. The distance between the opening auxiliary portion 40 and the back seal portion 20 was 20 mm. In addition, an opening start portion 21 as an I-notch was formed at a position which was located 20 mm from the end of the back seal portion 20 on the side of the first edge seal portion 30a.

As the resin sheet 10 of this example, a laminate sheet composed of a biaxially-stretched propylene film having a thickness of 20 μm as a base material, a polyurethane-based two liquid curable adhesive (coating amount 2.2 g/m²) containing polyether polyol and diisocyanate as an adhesion layer, and linear low-density polyethylene having a thickness of 40 μm as a heat-seal layer was used. In addition, the lamination strength between the base material and the heat-seal layer was 0.8 N/15 mm to 2.0 N/15 mm (average value: 1.2 N/15 mm).

### Example 2

A package bag was obtained in the same manner as in Example 1, except that as the resin sheet 10, a laminate sheet was used which was composed of a biaxially-stretched polyethylene terephthalate film having a thickness of 12 μm as a base material, a polyurethane-based two liquid curable adhesive (coating amount 2.2 g/m²) containing polyether polyol and diisocyanate as an adhesion layer, and linear low-density polyethylene having a thickness of 40 μm as a heat-seal layer, and whose lamination strength between the base material and the heat-seal layer was 1.5 N/15 mm to 2.5 N/15 mm (average value: 2.0 N/15 mm).

### Example 3

A package bag was obtained in the same manner as in Example 1, except that as the resin sheet 10, a laminate sheet was used which was composed of a biaxially-stretched polypropylene film having a thickness of 20 μm as a base material, a polyurethane-based two liquid curable adhesive (coating amount 3.3 g/m²) containing polyester polyol and diisocyanate as an adhesion layer, and linear low-density polyethylene having a thickness of 40 μm as a heat-seal layer, and whose lamination strength between the base material and the heat-seal layer was 1.5 N/15 mm to 3.0 N/15 mm (average value: 2.5 N/15 mm).

### Example 4

A package bag was obtained in the same manner as in Example 1, except that as the resin sheet 10, a laminate sheet was used which was composed of a biaxially-stretched polyethylene terephthalate film having a thickness of 12 μm as a base material, a polyurethane-based two liquid curable adhesive (coating amount 3.3 g/m²) containing polyester polyol and diisocyanate as an adhesion layer, and linear low-density polyethylene having a thickness of 40 μm as a heat-seal layer, and whose lamination strength between the base material and the heat-seal layer was 3.5 N/15 mm to 5.0 N/15 mm (average value: 4.2 N/15 mm).

### Comparative Example 1

A package bag was obtained in the same manner as in Example 1, except that as the resin sheet 10, a sheet formed of a heat-seal polypropylene film having a thickness of 20 μm as a base material without an opening auxiliary line was used.

### Comparative Example 2

A package bag was obtained in the same manner as in Example 1, except that one opening auxiliary portion 40 was provided on only one side of the back seal portion 20.

### (Evaluation)

Regarding each of the examples and comparative examples, the time for steaming by microwave cooking and the residual water content of Chinese steamed bun after microwave heating were measured as follows. The measurement results are shown in table 1. ER-E8 manufactured by Toshiba Corporation was used as a microwave and the heating was performed at 500 W for 70 seconds.

In addition, after the cooking, the size of the opening when the package bag was opened from the opening start point was visually evaluated.

The evaluation results are shown in Table 1.

In addition, the content (Chinese steamed bun) removing property after opening was evaluated under the following standards.

### (Time for Steaming)

A time (A) from when the heating was started with a microwave to when the package bag swelled to the maximum and a time (B) from when the heating was started to when the emission of the steam in the package bag to the outside was started were measured. The time for steaming is obtained through an expression (B)-(A). A longer time for steaming means that the food was cooked better.

### (Residual Water Content)

The residual water content of the skin of Chinese steamed bun after the microwave cooking was measured using an infrared moisture gauge (FD-610 manufactured by Kett Electric Laboratory). The residual water content before the cooking was set to 100%. The higher residual water content means that the food was cooked better.

### (Content Removing Property)

O: It was possible to easily remove the contents without scratching the surface of the contents.

X: It was difficult to remove the contents.

TABLE 1

| | | | | | COMPARATIVE | |
|---|---|---|---|---|---|---|
| | EXAMPLES | | | | EXAMPLES | |
| | 1 | 2 | 3 | 4 | 1 | 2 |
| NUMBER OF | 2 | 2 | 2 | 2 | 0 | 1 |
| OPENING | | | | | | |
| AUXILIARY | | | | | | |
| PORTIONS | | | | | | |
| RANGE OF | 0.8~2.0 | 1.5~2.5 | 1.5~3.0 | 3.5~5.0 | — | 0.8~2.0 |
| LAMINATION | | | | | | |
| STRENGTH | | | | | | |
| (N/15 mm) | | | | | | |
| AVERAGE OF | 1.2 | 2.0 | 2.5 | 4.2 | — | 1.2 |
| LAMINATION | | | | | | |
| STRENGTH | | | | | | |
| (N/15 mm) | | | | | | |
| TIME FOR | 12 | 10 | 9 | 3 | 4 | 9 |
| STEAMING | | | | | | |
| (sec) | | | | | | |
| RESIDUAL | 95.0 | 92.5 | 91.0 | 87.8 | 88.4 | 93.8 |
| WATER | | | | | | |
| CONTENT | | | | | | |
| (%) | | | | | | |
| OPENING | Large | Large | Large | Large | Small | Small |
| AFTER | | | | | | |
| PACKAGE | | | | | | |
| BAG IS | | | | | | |
| OPENED | | | | | | |
| CONTENT | ◯ | ◯ | ◯ | ◯ | X | X |
| REMOVING | | | | | | |
| PROPERTY | | | | | | |

In the case of the package bags of Examples 1 to 4 provided with two opening auxiliary portions, a sufficient time for steaming was secured and the residual water content after the cooking was also high. In addition, since a large opening was formed when the package bag was opened from the opening auxiliary portion, it was possible to easily remove the contents without scratching the surface thereof.

In the case of the package bag of Comparative Example 1 in which the resin sheet was a single layer sheet and there were no opening auxiliary portions, since the opening formed when the package bag was opened from the opening auxiliary portion was small, it was difficult to remove the contents.

In the case of the package bag of Comparative Example 2 provided with one opening auxiliary portion, the time for steaming was short and the residual water content after the cooking was low, as compared with Example 1 with the same lamination strength. In addition, since the opening formed when the package bag was opened from the opening auxiliary portion was small, it was difficult to remove the contents.

In addition, in Examples 1, 2, and 3, the through-hole had a small size of 2 mm×4 mm (rice grain size). Thus, while the package bag maintained a swollen state, the steam escaped with only a small sound. When the steam escapes like this, the steam effect is increased.

In Example 4, a large through-hole (5 mm×8 mm) was formed with a slightly loud sound from the swollen state, and thus the steam escaped instantaneously and the swollen package bag rapidly deflated. In this case, the steam effect is slightly lower than in Examples 1, 2, and 3.

In Comparative Example 1, the package bag was ruptured with a loud explosion. In this case, the steam effect is low.

### INDUSTRIAL APPLICABILITY

The present invention can be widely used when steam-cooking packaged food with a microwave.

### REFERENCE SIGNS LIST

1 Package bag
10 Resin sheet
11 Base material
12 Heat-seal layer
20 Back seal portion
21 Opening start portion
30A First edge seal portion
30B Second edge seal portion
40 Opening auxiliary portion

1. A package bag for microwave cooking in which food is seal-packaged, the package bag comprising:
a back seal portion formed by heat-sealing a pair of edges of a resin sheet which are opposed to each other; and
edge seal portions formed by heat-sealing edges of the resin sheet so that the edge seal portions intersect with the back seal portion,
wherein the resin sheet includes a base material and a heat-seal layer provided on one surface of the base material,
wherein the back seal portion is provided with an opening start portion used to tear the resin sheet, and
wherein in the resin sheet on a side on which the back seal portion is formed, at least one opening auxiliary portion formed by linearly cutting the base material is provided on each of both sides of the back seal portion, and the opening auxiliary portion is disposed in a position to which a tear caused in the resin sheet when the package bag is opened from the opening start portion proceeds.

2. The package bag for microwave cooking according to claim 1,
wherein a lamination strength between the base material and the heat-seal layer in the resin sheet is 0.1 N/15 mm to 3.0 N/15 mm.

3. The package bag for microwave cooking according to claim 1,
wherein the opening auxiliary portion is formed to be parallel to an extending direction of the back seal portion.
